(19) United States
(12) Patent Application Publication
(10) Pub. No.: US 2024/0147910 A1
(43) Pub. Date: May 9, 2024

(54) WINDROWER WITH PICKUP DEVICE

(71) Applicant: Maschinenfabrik Bernard Krone GmbH & Co. KG, Spelle (DE)

(72) Inventors: Andreas AFTING, Emsbüren (DE); Philip HERMES, Spelle (DE); Simon SPELLER, Hopsten (DE)

(21) Appl. No.: 18/502,659

(22) Filed: Nov. 6, 2023

(30) Foreign Application Priority Data
Nov. 9, 2022 (DE) DE102022129614.8

(51) Int. Cl. A01D 89/00

(52) U.S. Cl. CPC A01D 89/008; A01D 89/002; A01D 78/04

(57) ABSTRACT

The invention relates to a windrower (1), having a main frame (2), which can be supported via an undercarriage (4) in the operating state, and having at least one windrower unit (20), which is connected at least indirectly to the main frame (2) and has a pickup device (21), and a transverse conveyor (30), which is arranged at least predominantly behind it in relation to a windrower longitudinal axis (X) in a working configuration of the windrower (1) and has a transverse conveyor frame (31), wherein the pickup device (21) is configured, in the working configuration, to pick up agricultural crop material from the ground (50) and to transfer it to the transverse conveyor (30), and the transverse conveyor (30) is configured to convey the transferred crop material along a windrower transverse axis (Y) and deposit it in windrows on the ground (50). In order to enable improved dynamic adaptation to a ground profile in the case of a windrower, it is envisaged according to the invention that the pickup device (21) is vertically movable both relative to the transverse conveyor frame (31) and also relative to the main frame (2), at least in relation to a windrower vertical axis (Z)

### CROSS REFERENCE TO RELATED APPLICATIONS

This application claims priority under 35 U.S.C. § 119 to German Patent Application DE 10 2022 129614.8, filed Nov. 9, 2022, which is herein incorporated by reference in its entirety, including without limitation, the specification, claims, and abstract, as well as any figures, tables, appendices, or drawings thereof.

### FIELD OF THE INVENTION

The present invention relates to a windrower.

### BACKGROUND OF THE INVENTION

The background description provided herein gives context for the present disclosure. Work of the presently named inventors and aspects of the description that may not otherwise qualify as prior art at the time of filing are neither expressly nor impliedly admitted as prior art.

Windrowers are used in agriculture to gather crop material, e.g., grass, alfalfa, legumes, or hay, lying on the ground into windrows. This can serve, for example, to protect the crop material more effectively from moisture or to prepare it for subsequent pickup by a baler, a self-loading forage box, or the like. In general, the windrower conveys the crop material to one side or to the center, thereby giving rise to a windrow. One common windrower is the rotary windrower, which has one or more rotating rotary rakes, on each of which a plurality of prong arms rotates about a common axis. The prongs of a prong arm are guided close to the ground and, in the process, take up the crop material and take it along over a certain distance before it is deposited in a row. In order to control the deposition location at least approximately, at least one interception element (e.g., a crop curtain) is often provided, and this can be arranged radially outside the path of movement of the prongs.

Another type is the “belt-type windrower”, where the crop material is picked up from the ground by means of a pickup device, normally a pickup having at least one pickup rotor, and transferred to a downstream transverse conveyor. The said conveyor conveys the crop material transversely to the direction of travel by means of a conveyor belt or the like, and deposits it at the side. In comparison to a rotary windrower, this avoids a situation where the crop material is guided over the ground, a process during which it may be contaminated or even damaged. The prior art also includes belt-type windrowers having at least two windrower units, which are arranged individually on side arms, and each have a pickup device and a transverse conveyor. By means of different optional settings of the conveying direction, the crop material can then be deposited either on the left, on the right, or centrally.

To ensure that the crop material is picked up in an optimum manner, it is essential that the pickup device be guided at an approximately constant distance over the ground, even when the ground profile is uneven. For this purpose, there is a known practice of suspending the entire windrower unit in such a way that it can move relative to a main frame of the windrower, in particular of the belt-type windrower, thus enabling it to rise and fall to follow the profile of the ground. The problem here, however, is the large mass of the windrower unit, which makes it relatively inert. It is, therefore, virtually impossible to precisely follow a ground profile.

Therefore, there is a strong need for a windrower that provides improved dynamic adaptation to a ground profile.

### SUMMARY OF THE INVENTION

The following objects, features, advantages, aspects, and/or embodiments are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

An aspect of the invention is a windrower, having a main frame, which can be supported via an undercarriage in the operating state, and having at least one windrower unit, which is connected at least indirectly to the main frame and has a pickup device, and a transverse conveyor, which is arranged at least predominantly behind it in relation to a windrower longitudinal axis in a working configuration of the windrower and has a transverse conveyor frame, wherein the pickup device is configured, in the working configuration, to pick up agricultural crop material from the ground and to transfer it to the transverse conveyor, and the transverse conveyor is configured to convey the transferred crop material along a windrower transverse axis and deposit it in windrows on the ground, wherein the pickup device is vertically movable both relative to the transverse conveyor frame and relative to the main frame, at least in relation to a windrower vertical axis.

For this purpose, the invention provides a windrower, having a main frame, which can be supported via an undercarriage in the operating state, and having at least one windrower unit, which is connected to the main frame and has a pickup device, and a transverse conveyor, which is arranged at least predominantly behind it in relation to a windrower longitudinal axis in a working configuration of the windrower unit and has a transverse conveyor frame, wherein the pickup device is configured, in the working configuration, to pick up agricultural crop material from the ground and to transfer it to the transverse conveyor, and the transverse conveyor is configured to convey the transferred crop material along a windrower transverse axis and deposit it in windrows on the ground.

The windrower is used to deposit agricultural crop material, e.g., grass or hay, which is lying on the ground in a flat and/or random way, for example, in windrows. Machines of this kind are also referred to as mergers or as hay making machines, and their use is explicitly not restricted to hay. Normally, the windrower does not have its own travel drive and is provided so as to be towed by a tractor or else possibly to be carried as an attachment at the front or rear by an agricultural machine. However, an embodiment with its own travel drive is conceivable.

The windrower has a main frame. This main frame may form as if it were the central element of the windrower and may be substantially responsible for its structural stability. It is normally of intrinsically rigid design but can be made up of a plurality of interconnected components. In the operating state, the main frame can be supported by means of an undercarriage. The main frame can have the undercarriage, which is thus part of the windrower. If the windrower is designed as an attachment, it is coupled in the operating state to an agricultural machine that has the undercarriage. In either case, at least some of the weight of the windrower can be absorbed and supported on the ground via the main frame and the undercarriage. Moreover, the main frame can be designed for at least indirect connection to a tractor, and a drawbar used for this purpose can be regarded as part of the main frame. As an alternative, the main frame can have structures for connection to an agricultural machine, which allows use as an attachment.

At least one windrower unit is connected at least indirectly to the main frame. Typically, the windrower unit is connected to the main frame indirectly via at least one interposed element, not directly. Typically, either precisely one windrower unit or precisely two windrower units are provided. The respective windrower unit can be connected to a side arm which, for its part, is connected to the main frame or forms a part thereof. The windrower unit has those elements of the windrower which, in use as intended, come into direct contact with the crop material and transport the latter.

The respective windrower unit has a pickup device, and a transverse conveyor, which is arranged at least predominantly behind it in relation to a windrower longitudinal axis in a working configuration of the windrower and has a transverse conveyor frame. The working configuration denotes a configuration in which the windrower is located for field cultivation. Depending on the embodiment, it is possible for the windrower to assume only this configuration, but, typically, it can assume a number of configurations, e.g., for passing through a headland, for road transport, or the like. In other configurations, elements of the windrower and, in particular, the at least one windrower unit can be arranged in a different way, and therefore, the statements made here do not apply. It is also conceivable for the windrower to be able to assume a plurality of working configurations. In the working configuration, the transverse conveyor is arranged at least predominantly behind the pickup device, more specifically in relation to the windrower longitudinal axis, which normally runs parallel or anti-parallel to the direction of travel. Under certain circumstances, the pickup device and the transverse conveyor may partially overlap in relation to the windrower longitudinal axis. The pickup device is configured, in the working configuration, to pick up agricultural crop material from the ground and to transfer it to the transverse conveyor. For this purpose, the pickup device typically has at least one rotor, which picks up the crop material from the ground and conveys it upwards and rearwards by means of a rotary motion. In particular, it is possible to provide two rotors, one of which, the pickup rotor, picks up the crop material and transfers it to the second, the transfer rotor, which in turn transfers it to the transverse conveyor. In this context, the term “transfer” also includes throwing or dropping, where the crop material does not have any contact with the pickup device or with the transverse conveyor in the meantime.

The transverse conveyor is configured to convey the transferred crop material along a windrower transverse axis and to deposit it in windrows on the ground. For this purpose, the transverse conveyor has a conveying element, as a general rule, an endlessly circulating conveying element, e.g., a conveyor belt or link belt, but it could also be some other type of conveying element, e.g., a conveying screw. In the case of a conveyor belt or link belt, the windrower can also be referred to as a belt-type windrower. The windrower's transverse axis runs at a right angle to the abovementioned windrower's longitudinal axis. The transverse conveyor normally conveys the crop material parallel to the windrower transverse axis, but it could also convey it at a certain angle to the windrower transverse axis. Here, the transverse conveyor frame forms a component part of the transverse conveyor, which does not take part in the conveying movement and on which the conveying element is movably mounted. Overall, the transverse conveyor frame imparts mechanical stability to the transverse conveyor and is normally of intrinsically rigid design.

Normally, the transverse conveyor frame is at least vertically movable relative to the main frame in relation to a windrower vertical axis. The windrower vertical axis runs perpendicularly to the windrower longitudinal axis and to the windrower's transverse axis. It is generally in relation to this windrower vertical axis; therefore, that the transverse conveyor frame is vertically movable relative to the main frame. In other words, it is connected at least indirectly to the main frame in such a way that it is vertically movable relative to the latter. Accordingly, the transverse conveyor frame (and thus the transverse conveyor overall) can adopt different vertical positions relative to the main frame. Mobility can be provided in a purely passive way; the transverse conveyor frame is thus movable by means of external forces. Alternatively, or in addition, it is also possible to provide at least one actuator in order to actively change the vertical position. In addition to the mobility along the windrower's vertical axis, there may also be mobility along the windrower's longitudinal axis and/or the windrower's transverse axis. In particular, the transverse conveyor frame does not have to be movable parallel to the windrower vertical axis. Apart from translational movements of the transverse conveyor frame, rotational movement is also conceivable, e.g., transverse oscillation (corresponding to a rotation about the windrower longitudinal axis).

According to the invention, the pickup device is vertically movable both relative to the transverse conveyor frame and relative to the main frame, at least in relation to the windrower vertical axis. This refers to the pickup device in its entirety, which can change its vertical position in relation to the windrow vertical axis both relative to the main frame and relative to the transverse conveyor frame. This can refer both to passive mobility and to active mobility by means of one or more actuators. It is possible for a movement along the windrower longitudinal axis and/or the windrower transverse access or even a rotational movement to be superimposed on the movement in relation to the windrower vertical axis. In all cases, it is possible to raise and lower the pickup device in this way, even without raising and lowering the transverse conveyor frame or the transverse conveyor. The pickup device can, therefore, rise and fall relative to the main frame, following a ground profile, without having to move the transverse conveyor at the same time in order to achieve this. That is to say that the mass of the transverse conveyor, which must be regarded in general as a considerable mass, can remain at one level, thereby allowing dynamic adaptation to ground irregularities within a short time. The windrower unit can, therefore, react more quickly and precisely to the current ground profile.

On the one hand, it is possible to connect the pickup device to the main frame in a manner entirely independent of the transverse conveyor, thus providing vertical mobility relative to the transverse conveyor frame. Another embodiment envisages that the pickup device is connected in a vertically movable manner to the transverse conveyor frame via a pickup suspension. In this case, therefore, the pickup device is connected to the main frame via the pickup suspension and the transverse conveyor frame (and optionally additional interposed elements). In other words, the flow of force between the main frame and the pickup device runs via the transverse conveyor frame. In this case, the pickup suspension is designed in such a way that it allows the envisaged vertical mobility. It can have a linear guide, for example. In addition, or especially as an alternative, it can have at least one suspension link, which is pivotably connected both to the pickup suspension and to the transverse conveyor frame. Other suspension elements, not mentioned here, can also be used to implement the pickup suspension. Although a further attachment of the pickup device to the main frame is not excluded, it is preferred in this embodiment that the pickup device is connected to the main frame exclusively via the pickup suspension and the transverse conveyor frame. In particular, the pickup suspension can be of fully passive design, but it could also have at least one active element, e.g., an actuator. It is also possible for the pickup suspension to have at least one return element or spring element, which produces a restoring force, dependent on the deflection of the pickup device, between the latter and the transverse conveyor frame. In this way, the transverse conveyor could, for example, follow the movements of the pickup device with a time delay, or vice versa.

For optimum use of the available installation space and in order to avoid hindering the conveyance of the crop material on the upper side of the transverse conveyor, it is preferred that the pickup suspension is arranged at least in part below the transverse conveyor. This arrangement is also advantageous in as much as maintenance, repair, and, where applicable, adjustment of the pickup suspension can be performed without removing the transverse conveyor. As an alternative or at the same time, it is also conceivable, however, that the pickup suspension is arranged at least in part within the transverse conveyor. In this case, at least one element of the pickup suspension can be passed through the transverse conveyor.

The pickup suspension preferably has a plurality of suspension units spaced apart along the windrower transverse axis. Normally, two or three suspension units are provided, but a larger number would also be possible. Preferably, the suspension units are mechanically independent of one another, and therefore, each suspension unit allows vertical adjustment of a certain section of the pickup device. In this case, therefore, it is also possible, apart from raising or lowering the entire pickup device, to raise part (e.g., the left-hand side) of the pickup device while another part (e.g., the right-hand side) remains at the same level or is lowered.

At least one suspension unit can have a suspension link which extends forwards to the pickup device from a region of the transverse conveyor frame, which is at the rear in relation to the windrower longitudinal axis. The suspension link is of an intrinsically rigid design and is connected pivotably both to the transverse conveyor frame and to the pickup device. The respective pivot bearing can have one or more degrees of freedom. A change in the height of the pickup device corresponds to a pivoting movement of the suspension link. Since the pickup device is arranged at least predominantly ahead of the transverse conveyor, the suspension link must be of relatively long design in order to extend from the rear region to the pickup device. Its length can correspond to between 70% and 150% of the length of the transverse conveyor frame along the windrower longitudinal axis, for example. In accordance with the relatively long length, a certain change in height can be achieved with a relatively small pivoting angle. This allows virtually rectilinear displacement and/or displacement which takes place predominantly in the direction of the windrower vertical axis. In comparison with a linear guide, however, connection by means of a suspension link is simpler to implement, less prone to faults, and also requires less maintenance. As a general rule, it is necessary for at least one suspension link to be configured to absorb forces acting along the windrower transverse axis between the suspension unit and the transverse conveyor frame. This suspension link stabilizes the suspension unit in relation to the windrower transverse axis. On the side of the transverse conveyor frame, for example, it can have a pivot bearing with just one degree of freedom, which permits only a pivoting movement about the windrower transverse axis. A link that provides such stabilization can also be referred to as a transverse guide link.

Preferably, at least one suspension unit has a double-link suspension. That is to say that, in this case, two suspension links are provided, being connected pivotably to the transverse conveyor frame at one end and pivotably to the pickup device at the other end. In particular, this can be a parallelogram suspension. In the case of an ideal parallelogram suspension, the length of the two suspension links (to be more precise, the distance between the pivot bearings at the ends) is identical, and the suspension links are exactly parallel. In this context, however, a suspension in which the lengths of the suspension links differ slightly from one another, e.g., by a maximum of 5%, and a suspension in which the links do not run exactly parallel but at a small angle of, for example, a maximum of 10°, is still regarded as a “parallelogram suspension”. The parallelogram suspension ensures that, in the case of a translational vertical displacement of the pickup device relative to the transverse conveyor frame, there is no (or only a negligible) rotational movement of the pickup device. That is to say that the pickup device always remains in the same orientation. In principle, the double-link suspension can be implemented with simple pivot bearings, i.e., which have just one degree of freedom. In many cases, however, it is advantageous or even necessary to employ pivot bearings with several degrees of freedom, e.g., ball joints. This embodiment can be combined with the one mentioned above, the suspension links of the double-link suspension, thus being connected to the rear region of the transverse conveyor frame. As described above, one of the two links of a double-link suspension can be designed as a transverse guide link. Often, however, this function can be implemented by means of a single suspension link.

The prior art includes pickup devices which push the crop material as if it were onto a transverse conveyor. Such a configuration, in which the transfer of the crop material takes place as it were in one plane, is not excluded in the context of the present invention but can lead to problems if the vertical position of the pickup device relative to the transverse conveyor changes. There is therefore a preference for the pickup device to be configured to discharge the crop material above the transverse conveyor in relation to the windrower vertical axis and to throw it onto the said conveyor. An embodiment of this kind can be implemented, in particular, but not exclusively, using two rotors, of which a pickup rotor picks up the crop material from the ground and transfers it to a transfer rotor arranged at a higher level. In all cases, the pickup device in this embodiment extends at a higher level than the transverse conveyor, irrespective of the current deflection of the pickup device relative to the transverse conveyor frame. Depending on the embodiment, it may not be possible to determine exactly at what point and thus at what height the crop material is discharged from the pickup device. Normally, however, it is possible to identify a typical discharge region. In the embodiment described here, this discharge region is above the transverse conveyor. That is to say that the crop material is thrown off either perpendicularly or obliquely onto the transverse conveyor.

For various reasons, it may be advantageous to limit the movement of the pickup device relative to the transverse conveyor frame, e.g., because an extreme change in height would significantly impair the transfer of crop material. One embodiment envisages that the pickup device can be deflected relative to the transverse conveyor frame as far as a stop position, upon reaching which the pickup device interacts with the transverse conveyor frame via a positive engagement acting along the windrower vertical axis. Although the word “a” stop position has been used here, a preferred possibility is one where an upper stop position and a lower stop position are defined. Until the respective stop position is reached, the pickup device is capable of vertical movement relative to the transverse conveyor. Once the stop position is reached, there is a positive engagement, which acts along the windrower's vertical axis, i.e., at least proportionately in the vertical direction. By means of this positive engagement, further vertical movement of the pickup device is only possible if the transverse conveyor frame moves with it at the same time. The positive engagement can be established directly between the pickup device and the transverse conveyor frame, but, according to a typical embodiment, its formation involves the participation of at least one interposed element. In particular, it can be formed between the pickup suspension and the transverse conveyor frame.

According to a preferred embodiment, a stop position is defined by one end of an aperture, which extends along the windrower vertical axis, is closed on at least one side, and into which there engages a stop part, which, when the pickup device is deflected along the windrower vertical axis, can be deflected relative to the aperture. In particular, in the case of two stop positions, this can apply to both stop positions. The aperture can be designed as a slot or elongated hole, for example. If the aperture is closed on only one side, only one stop position is defined. If the aperture is closed on both sides, it defines two stop positions. In particular, the aperture can be formed in or on the transverse conveyor frame. The stop part engages in the aperture and, in particular, can be passed through it. It can be rigidly connected to the pickup device. However, it can also be designed as a suspension part of the pickup suspension, which is passed through the aperture, normally along the windrower longitudinal axis. Conversely, however, it would also be possible for the stop part to be arranged on the transverse conveyor frame, and the aperture could be formed on the pickup device or on the pickup suspension. Within a certain range, the stop part can move freely within the aperture when the vertical position of the pickup device changes. When the stop position is reached, there is positive engagement between the edge of the aperture and the stop part. In particular, the abovementioned suspension part can be a suspension link which is connected pivotably to the transverse conveyor frame at one end and pivotably to the pickup device at the other end. This can be a single suspension link or, in particular, a suspension link of an aforementioned double-link suspension.

The pickup device preferably has ground guidance elements, via which it can be supported at least proportionately on the ground. The ground guidance elements serve, on the one hand, to transfer at least some of the weight of the pickup device to the ground, ensuring that it is not transferred to the transverse conveyor frame and/or the main frame. In particular, however, the ground guidance elements serve, as it were to sense the ground profile and thus maintain an optimum clearance of the pickup device with respect to the ground. That is to say that the pickup device is guided along the ground profile by means of the ground guidance elements. In particular, the ground guidance elements could be wheels, rollers, rolls, or even skids. The ground guidance elements can form part of the pickup device or can be connected directly to the latter. However, it would also be possible for the ground guidance elements to be connected to a part of the pickup suspension, which is adjacent to the pickup device. In particular, it is possible here for a ground guidance element to be assigned to each suspension part.

Alternatively, or, in particular, in addition to the transfer of some of the weight via the aforementioned ground guidance elements, some of the weight can be absorbed by the transverse conveyor frame. This must, of course, take place in a manner which allows the vertical mobility of the pickup device. According to one such embodiment, the pickup device is connected to the transverse conveyor frame by at least one spring element, which is designed to exert a tensile force acting at least proportionately along the windrower vertical axis. As a preferred option, a plurality of such spring elements can be provided. The respective spring element connects the pickup device to the transverse conveyor frame and produces a tensile force which relieves the load on the pickup device. Correspondingly, there is, of course, an additional load on the transverse conveyor frame. It will be understood that the tensile force exerted is dependent on the position of the pickup device relative to the transverse conveyor. The same thus also applies to the relative proportion of the weight which is transferred by the spring element to the transverse conveyor frame. The spring element can be regarded as part of the pickup suspension. In particular, it can be designed as a linear spring. It could be a mechanical spring, e.g., a helical spring. In particular, the spring element can be designed as a hydraulic cylinder or hydropneumatic cylinder. In the case of such a cylinder, the tensile force can also be adapted by changing the hydraulic pressure.

By means of the vertical mobility of the pickup device, a high capacity for adaptation to a changing ground profile is already achieved in the windrower, according to the invention. However, owing to the typical width of the windrower unit, which may be several meters along the windrower transverse axis, it can be expected that the ground profile will also vary across the width of the windrower unit. To counteract this problem, it is envisaged, in an advantageous development of the invention, that the pickup device has two subunits, which are offset with respect to one another along the windrower transverse axis and can be tilted relative to one another about a bending axis extending at least proportionately along the windrower longitudinal axis, wherein the subunits are vertically movable relative to the transverse conveyor frame, at least partially independently of one another. The two subunits are physically separated but can preferably be connected in terms of force transmission in order, in particular, to transmit a rotary motion of a rotor. In this case, the respective rotor consists of two partial rotors or rotor halves, which can be connected to one another by a suitable coupling. On the one hand, the coupling should transmit a rotary motion, but on the other hand, it should also be able to bridge a varying gap which forms when the subunits tilt. The two subunits can tilt about a bending axis relative to one another. The bending axis can run parallel to the windrower longitudinal axis or at an angle thereto, but not perpendicular thereto. Typically, the angle is a maximum of 30°. Depending on the embodiment of the connection between the subunits, the bending axis may not be clearly defined or may be variable. It is also conceivable that tilting with several degrees of freedom, i.e., tilting about several bending axes, is possible.

As a result of the tilting, one or both sides of the pickup device can fall or rise, while the center maintains its height, or vice versa. It is also conceivable for one side and the center to fall or rise, while the other side maintains its height. These are just some examples. If ground guidance elements are provided, each subunit is assigned at least one ground guidance element, wherein one subunit may also have two such elements. Preferably, in each case, one ground guidance element is arranged laterally on the outside, and one ground guidance element is arranged close to the center of the pickup device. It is likewise preferred that each subunit is connected to the transverse conveyor frame via at least one suspension unit assigned to it. That is to say that each subunit is assigned at least one suspension unit of the pickup suspension. The corresponding suspension unit connects this subunit to the transverse conveyor frame. One of the subunits can be connected to the transverse conveyor frame via two suspension units. Each of the subunits can be connected to the transverse conveyor frame via a double-link suspension. At least one subunit can be attached via a transverse guide link. If the subunits are connected in such a way that transverse forces are transmitted between them, it is sufficient to provide one transverse guide link for precisely one subunit. One possible configuration envisages that each subunit has a double-link suspension on the outside, while one of the subunits is connected to the transverse conveyor frame via a single transverse guide link close to the center of the pickup device.

One embodiment envisages that the transverse conveyor frame is connected at least indirectly to the main frame via a central link and two lateral links, which are offset laterally along the windrower transverse axis with respect to the said central link and are at least partially offset with respect thereto along the windrower vertical axis, wherein the central link and the lateral links are pivotably attached on both sides independently of one another and wherein each lateral link can be pivoted by an actuator. The said links can either be connected directly to the main frame or to an interposed component connected to the said frame. Each of the links is connected pivotably to the transverse conveyor frame and to the main frame or the interposed component independently of the other two links. The lateral links are arranged on both sides of the central link and are at least partially offset with respect thereto in relation to the vertical axis. They are, therefore, arranged either at least in part above the central link or at least in part below it. In the latter case, the central link can be referred to as an upper link and the lateral links as lower links. Depending on the embodiment, these lower links are arranged completely below the upper link, at least in the working configuration. In a corresponding fashion, it is also possible to conceive of an embodiment in which the lateral links are arranged completely above the central link. The transverse conveyor frame can have a holding section which extends upwards or else downwards and to which the central link is connected. If the lateral links are designed as lower links, they can be connected to the underside of the transverse conveyor frame. The length of the central link is preferably adjustable by means of an actuator, wherein it can have a linear actuator, e.g., a hydraulic cylinder. Here, the corresponding actuator is referred to as a central-link actuator or upper-link actuator, in particular, a central-link cylinder or upper-link cylinder. The lateral links can be pivoted by means of an actuator, for which purpose respective linear actuators can be connected to a lateral link and on the main-frame side. These linear actuators can also be designed as hydraulic cylinders. They are referred to below as lateral-link actuators or lower-link actuators or, more specifically, as lateral-link actuators or lower-link cylinders. The central-link actuator can be used for fine adjustment of a working height of the pickup device and/or for lifting up the windrower unit in a headland. The lateral-link actuators can likewise be used for lifting up the unit. Moreover, they can be used to set how much of the weight of the pickup device is absorbed by the transverse conveyor frame, i.e., to what extent the pickup device is relieved of load. However, it is also possible to use a separate component for this purpose, e.g., a spring element. Apart from active adjustment of the transverse conveyor frame, the lateral-link actuators can also act as passive spring elements, if they are designed as hydraulic cylinders for example, enabling the transverse conveyor to adopt different vertical positions, for example, when the pickup device has reached a stop position, and the transverse conveyor has to move with it. Moreover, they can enable the transverse conveyor and the entire windrower unit to perform a transverse oscillation.

In this context, it is regarded as an independent invention to provide a windrower in which the transverse conveyor frame is connected at least indirectly to the main frame via a central link and two lateral links, which are offset laterally along the windrower transverse axis with respect to the said central link and are at least partially offset with respect thereto along the windrower vertical axis, wherein the central link and the lateral links are pivotably attached on both sides independently of one another and wherein each lateral link can be pivoted by an actuator.

One embodiment envisages that the central link and the lateral links are connected to a suspension frame, which can be pivoted by an actuator relative to the main frame about a transport pivoting axis running at least proportionately along the windrower transverse axis. The suspension frame is connected at least indirectly to the main frame. It forms an intrinsically rigid structure to which the central link and the lateral links are connected. However, it is not rigidly connected to the main frame but can be pivoted about the aforementioned transport pivoting axis. For this purpose, one or more actuators, in particular linear actuators such as hydraulic cylinders, can be used. The transport pivoting axis preferably runs horizontally, as a further preference parallel to the windrower transverse axis. By pivoting it about the transport pivoting axis, it is possible to transfer the windrower unit, including the suspension frame, into a transport position for travel on roads, for example.

The main frame preferably has two side arms, wherein a respective windrower unit is connected at least indirectly to each side arm. That is to say that, in this case, two windrower units are provided, and it is possible, in particular, for these to be of identical or mirror-symmetrical design. Each windrower unit can have the abovementioned features according to the invention and/or optional features. The main frame has side arms, which are normally elongate. In the working configuration, the side arms extend along the windrower transverse axis on both sides of the main frame. They are of sufficiently stable design to absorb at least some of the weight of the respective windrower unit, ensuring that this weight is introduced into the main frame and transmitted via the undercarriage to the ground. The aforementioned suspension frame can be connected to the side arm. The windrower unit can be adjustable along the side arm along the windrower transverse axis, e.g., in order to achieve different spacings of the windrower units, which can be used for different deposition modes, e.g., central deposition, lateral deposition, or separate deposition by each individual windrower unit. For their part, the side arms can be connected adjustably to the main frame.

It is expressly pointed out that the above-described embodiments of the invention can be combined in each case individually, but also in any combinations with one another, with the subject matter of the main claim, provided that no technically compelling obstacles are in conflict therewith.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

Further modifications and embodiments of the invention can be derived from the following description of the subject matter and the drawings.

### BRIEF DESCRIPTION OF THE DRAWINGS

Several embodiments in which the present invention can be practiced are illustrated and described in detail, wherein like reference characters represent like components throughout the several views. The figures are presented for exemplary purposes and may not be to scale unless otherwise indicated. Further details and advantages of the invention can be found in the schematic figures described below.

The invention is described below with reference to figures. The figures are purely illustrative and do not limit the general concept of the invention. More specifically:

FIG. 1 shows a perspective view of a windrower according to the invention;

FIG. 2 shows a perspective view of a lateral part of the windrower from FIG. 1;

FIG. 3 shows a perspective view of parts of a windrower unit of the windrower from FIG. 1;

FIG. 4 shows another perspective view of parts of the windrower unit from FIG. 3;

FIG. 5A shows a side view of the lateral part of the windrower, which is shown in FIG. 2, with the windrower unit in a different vertical position;

FIG. 5B shows a side view of the lateral part of the windrower, which is shown in FIG. 2, with the windrower unit in a different vertical position;

FIG. 6 shows a side view of the lateral part of the windrower with the windrower unit in one pendulum position; and

FIG. 7 shows a front view of the lateral part with the windrower unit in the pendulum position.

An artisan of ordinary skill in the art need not view, within isolated figure(s), the near infinite number of distinct permutations of features described in the following detailed description to facilitate an understanding of the present invention.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit basic operation of the present invention unless otherwise indicated. The hereinafter elucidated features may also be an aspect of the invention individually or in combinations other than those shown or described, but always at least in combination with the features of the claims. Where appropriate, functionally equivalent parts are provided with identical reference numbers.

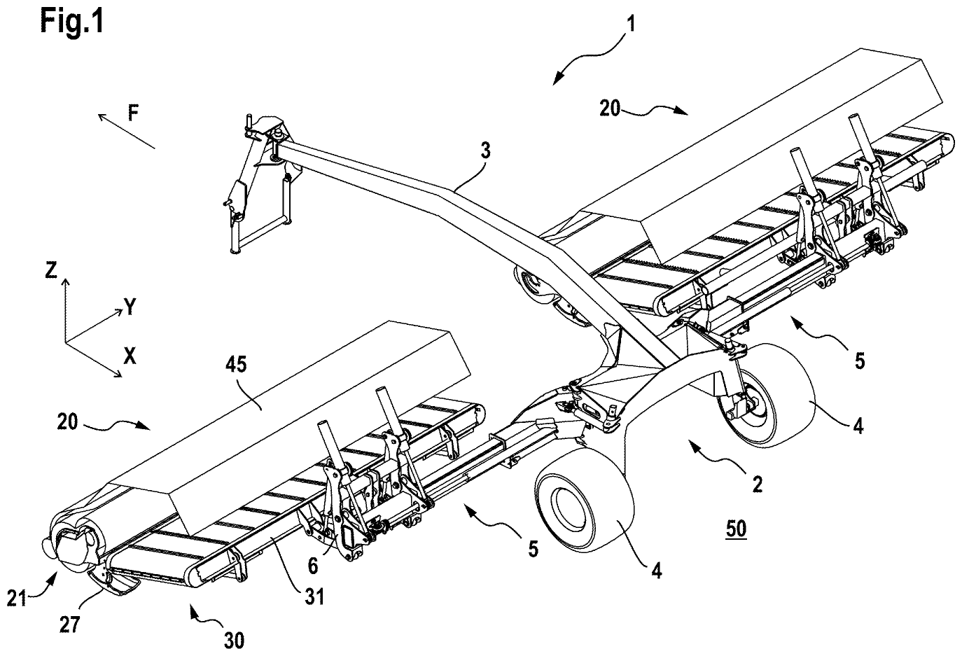

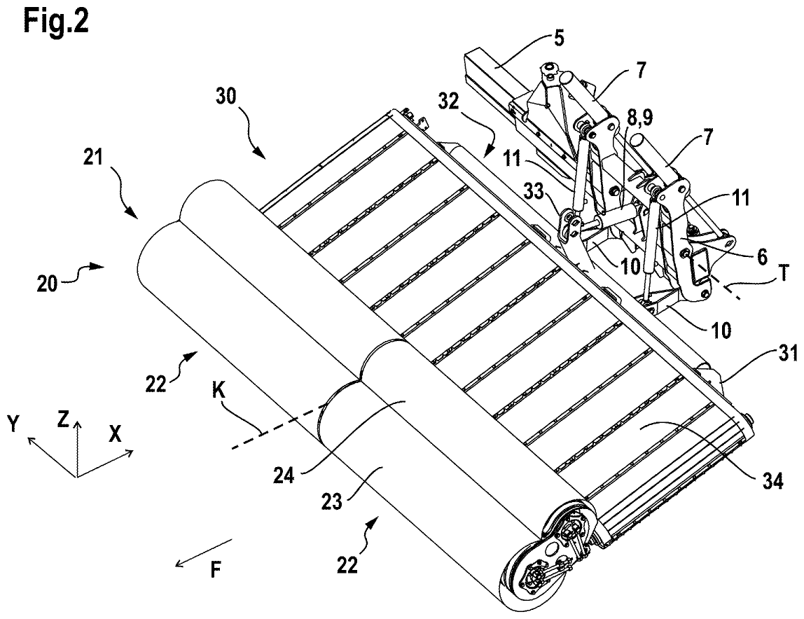

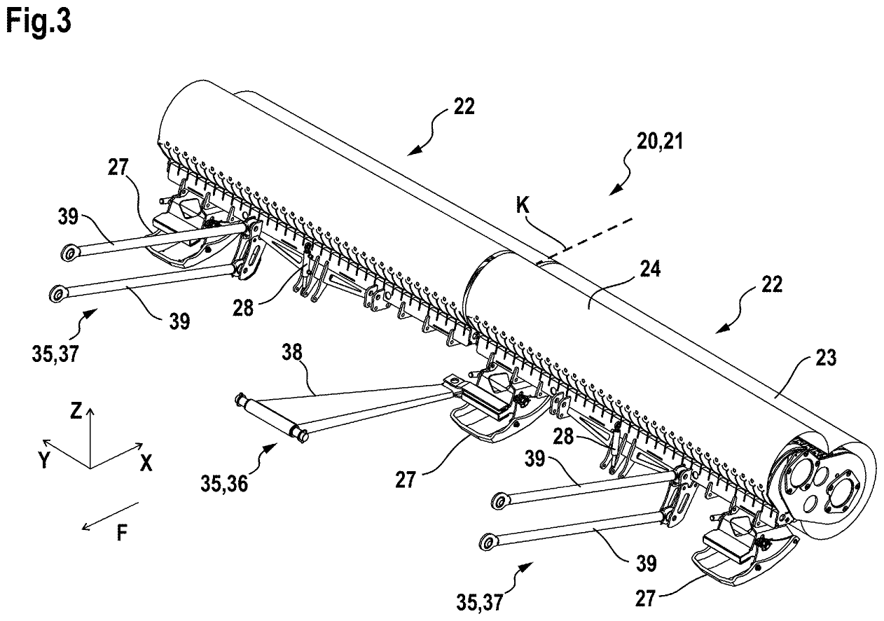

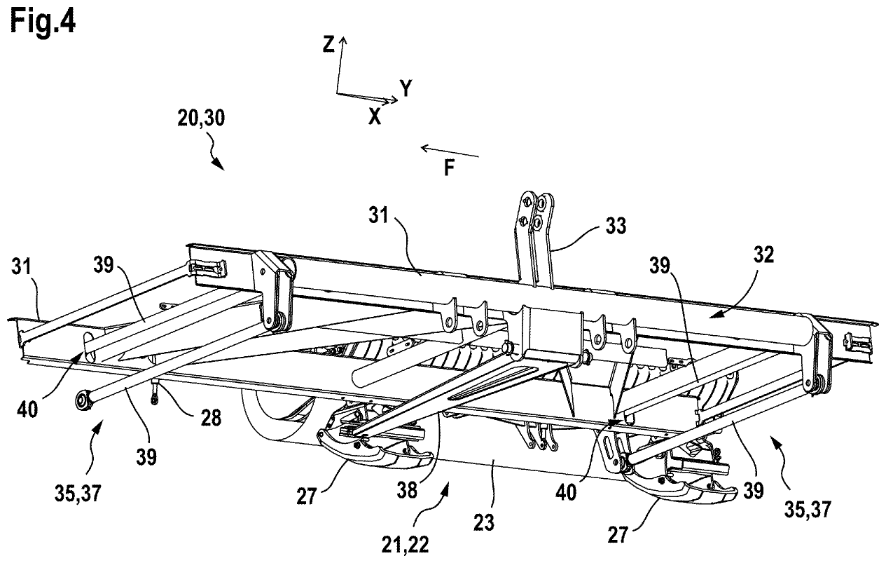

FIG. 1 shows a windrower 1 according to the invention, which is provided for towing by a tractor (not illustrated here). The windrower 1 has a main frame 2, which can be supported on the ground 50 via two wheels of an undercarriage 4. In addition, the main frame 2 has a drawbar 3, which points forwards in a direction of travel F, which extends along a windrower longitudinal axis X, and via which it is coupled to the tractor. Two side arms 5, on each of which a windrower unit 20 is arranged, extend parallel to a windrower transverse axis Y on both sides of the main frame 2. The two windrower units 20 and their connection to the main frame 2 are identical or mirror-symmetrical, for which reason only one windrower unit 20 is considered below in each case.

The windrower unit 20 has a pickup device 21 and a transverse conveyor 30, which is arranged behind the latter in relation to the windrower longitudinal axis X. The transverse conveyor 30 has a conveyor belt 34, for which reason the windrower 1 can also be referred to as a belt-type windrower. When the windrower 1 is towed in the direction of travel F, the pickup device 21 picks up crop material from the ground 50 and transfers it to the transverse conveyor 30. For this purpose, the pickup device 21 has a pickup rotor 23, which can be driven in rotation and is guided along close to the ground 50, and a transfer rotor 24, which can likewise be driven in rotation and is offset rearwards in relation to the windrower longitudinal axis X and upwards in relation to a windrower vertical axis Z relative to the pickup rotor 23. Both rotors 23, 24 have a plurality of prongs, which are not illustrated in the figures for reasons of clarity. Instead, the cylindrical enveloping surfaces of the ranges of movement of the respective prongs are illustrated in each case.

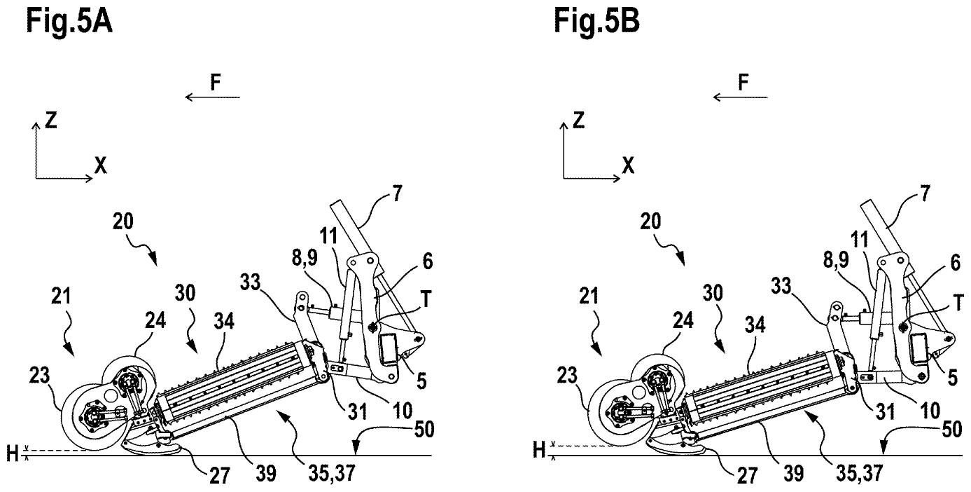

As can be seen especially in the side views in FIGS. 5A and 5B, the transfer rotor 24 of the pickup device 21 extends at a significantly higher level than the conveyor belt 34 of the transverse conveyor 30 in relation to the windrower vertical axis Z, thus enabling the crop material to be thrown off onto the conveyor belt 34 from above. The conveyor belt 34, in turn, conveys the crop material sideways along the windrower transverse axis Y, either towards the outside or towards the inside, where it is deposited in windrows. To prevent crop material from being lost and, overall, to improve the guidance of the crop material on the way to the conveyor belt 34, each windrower unit 20 is provided with a hold-down device 45, which, for the sake of clarity, is illustrated only partially in FIG. 1 and is omitted entirely in the other figures.

FIG. 1 shows a working configuration of the windrower 1, which is provided for the deposition of the crop material on the inside, i.e., towards the central plane of the windrower 1. In this case, the two windrower units 20 are clearly spaced apart along the windrower transverse axis Y, and the conveyor belts 34 are driven in such a way that they each convey the crop material towards the center. In an alternative working configuration (not illustrated here), the windrower units 20 can be adjusted towards the center on the side arms 5, such that they are arranged directly adjacent to one another. In this case, the conveyor belts 34 can be operated so as to run in the same direction, with the result that the crop material is deposited towards one side.

The transverse conveyor 30 has a transverse conveyor frame 31, which gives it structural stability and on which the circulating conveyor belt 34 is mounted. Connected to the transverse conveyor frame 31 is a pickup suspension 35, which connects the pickup device 21 movably to the transverse conveyor 30. In particular, by virtue of the design, explained below, of the pickup suspension 35, the pickup device 21 is vertically movable both relative to the transverse conveyor frame 31 and relative to the main frame 2. Accordingly, the pickup device can sense a profile of the ground 50 by means of ground guidance elements 27, which are here designed as skids, and follow at least relatively small irregularities without the need for the transverse conveyor 30 to change its vertical position for this purpose. In the present case, the pickup suspension 35 has three suspension units 36, 37 spaced apart along the windrower transverse axis Y. The pickup device 21 has two subunits 22, which are offset with respect to one another along the windrow transverse axis Y and can be tilted relative to one another about a bending axis K extending at least proportionately along the windrower longitudinal axis X. In corresponding fashion, the two rotors 23, 24 are likewise divided in two, wherein the respective rotor halves are coupled to one another for transmission of rotation by a suitable coupling (not illustrated).

One of the subunits 22, in this case the subunit 22 on the left, when viewed in the direction of travel, is assigned two ground guidance elements 27 and two suspension units 36, 37. Here, a lateral suspension unit 37 is designed as a parallelogram suspension with two suspension links 39 guided in parallel, which are connected pivotably to a rear region 32 of the transverse conveyor frame 31 and to the pickup device 21. A central suspension unit 36 has a single suspension link 38, which is likewise connected pivotably to the rear region 32 and to the pickup device 21. In this case, the other subunit 22, which is on the right in relation to the direction of travel F, is assigned only a lateral suspension unit 37, which, once again, is designed as a parallelogram suspension with two parallel suspension links 39. Pivoting of the suspension links 38, 39 enables the pickup device 21 to change its height relative to the transverse conveyor frame 31, while, at the same time, a slight displacement along the windrower longitudinal axis occurs, although this is negligible. Since each subunit 22 is assigned a parallelogram suspension, it maintains the same orientation about the windrower transverse axis Y at all times when there is a movement relative to the transverse conveyor frame 31. The central suspension link 38 is connected to the transverse conveyor frame 31 via a pivot bearing with just one degree of freedom. This allows only a pivoting movement about the windrower transverse axis Y. Accordingly, this central suspension link 38, as a transverse guide link, can absorb forces which act along the windrower transverse axis Y between the pickup device 21 and the transverse conveyor frame 31.

While, in this example, the central suspension link 38 runs below the transverse conveyor and is, as it were, capable of free movement, the upper one of the lateral suspension links 39 runs within the transverse conveyor 30 and is passed through an aperture, e.g., elongate hole, 40 within the transverse conveyor frame 31. The aperture 40 extends along the windrower vertical axis Z and, by virtue of its finite extent, defines by means of its ends an upper stop position and a lower stop position, between which the pickup device 21 or, to be more precise, the respective subunit 22 can move relative to the transverse conveyor frame 31. Until one of the stop positions is reached, the movement of the pickup device 21 is influenced, on the one hand, by its own weight and, on the other hand, by the force exerted by the ground 50 via the ground guidance elements 27. In addition, however, part of the weight is transferred to the transverse conveyor frame 31 via spring elements 28, which in the present case are designed as hydraulic cylinders. The spring elements 28 can thus also be referred to as load relief elements. When one of the stop positions is reached, the pickup device 21 is coupled by positive engagement to the transverse conveyor frame 31, and therefore, they can then only be moved jointly in the corresponding direction. This takes place via the suspension of the transverse conveyor 30, which is described below.

The transverse conveyor frame 31 is connected to a suspension frame 6 via an upper link 8 designed as an upper-link cylinder 9 (which forms a central link) and two lower lateral links 10 (which form lateral links), which are offset laterally with respect to the upper link along the windrower transverse axis Y and are arranged below it in relation to the windrower vertical axis Z. The upper-link cylinder 9, which is here designed as a hydraulic cylinder, is of adjustable length and is connected to the suspension frame 6, on the one hand, and to a vertical extension arm 33 of the transverse conveyor frame 31, on the other hand, via pivot bearings (without reference signs). The lower lateral links 10 are likewise connected to the transverse conveyor frame 31 and the suspension frame 6 via pivot bearings. Connected to each lower lateral link 10 is a lower-link cylinder 11, which is likewise designed as a hydraulic cylinder and is connected pivotably to the lower lateral link 10 and to the suspension frame 6. The suspension frame 6, for its part, is connected to the side arm 5 in such a way as to be pivotable about a transport pivoting axis T and can be pivoted upwards by means of two cylinders 7 into a transport position (not illustrated here).

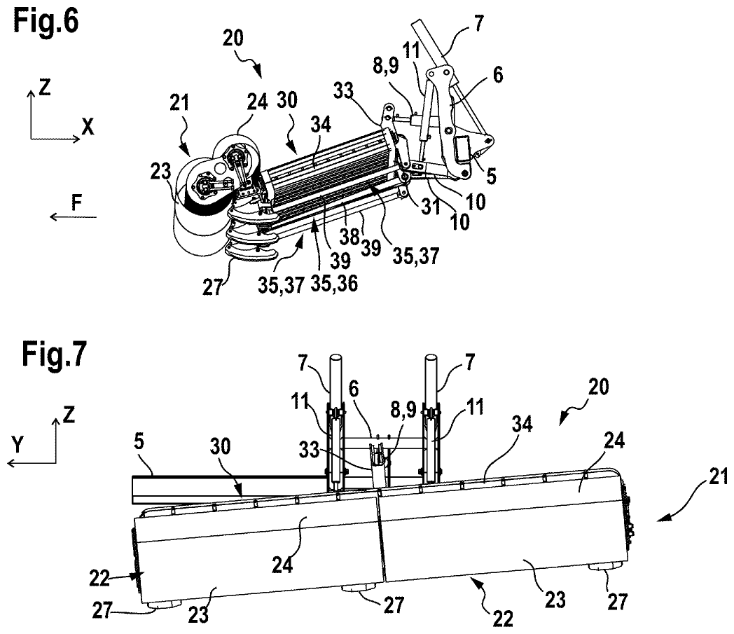

By adjusting the length of the upper link 8, it is possible to raise the windrower unit 20, e.g., in a headland. Moreover, it is possible by this means to perform fine adjustment of a working height H of the pickup device 21, as illustrated in FIGS. 5A and 5B. FIG. 5A shows a state in which the upper-link cylinder 9 has been extended a relatively long way, as a result of which the entire windrower unit 20 has been pivoted in such a way that a relatively small working height, i.e., a small clearance between the pickup rotor 23 and the ground 50, is obtained. FIG. 5B, in contrast, shows the state in which the upper-link cylinder 8 has been retracted further, as a result of which the entire windrower unit has been pivoted in such a way that a large working height H is obtained. Raising in the headland can be at least assisted by means of the lower-link cylinders 11. Moreover, the lower-link cylinders 11 act as spring elements, which transfer some of the weight of the windrower unit 20 to the main frame 2 via the suspension frame 6. By means of its passive deflection, the windrower unit 20 as a whole can be deflected upwards or downwards, e.g., when the pickup device 21 has reached one of the stop positions. By means of differential, i.e., asymmetric, deflection of the two lower lateral links 10 and an accompanying differential compression or expansion of the lower-link cylinders 11, the windrower unit 20 can also perform a transverse oscillation, which is illustrated in FIGS. 6 and 7.

From the foregoing, it can be seen that the present invention accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 1 | Windrower |
| 2 | Main frame |
| 3 | Drawbar |
| 4 | Undercarriage |
| 5 | Side arm(s) |
| 6 | Suspension Frame |
| 8 | Upper link |
| 9 | Upper link cylinder |
| 10 | Lateral link(s) |
| 11 | Lower link cylinder |
| 20 | Windower unit(s) |
| 21 | Pickup device |
| 22 | Subunit(s) |
| 23 | Pickup rotor |
| 24 | Transfer rotor |
| 27 | Ground guidance elements |
| 28 | Spring elements |
| 30 | Transverse conveyor |
| 31 | Transverse conveyor frame |
| 32 | Region |
| 33 | Vertical extension arm |
| 34 | Conveyor belt |
| 35 | Pickup suspension |
| 36 | Suspension unit(s) |
| 37 | Lateral suspension unit(s) |
| 38 | Suspension link |
| 39 | Suspension link(s) |
| 40 | Aperture, e.g., elongate hole |
| 45 | Hold-down device |
| 50 | Ground |
| F | Direction of travel |
| H | Working height |
| K | Bending axis |
| T | Transport pivoting axis |
| X | Longitudinal axis |
| Y | Transverse axis |
| Z | Vertical axis |

### Glossary

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein, refers to slight variations in numerical quantities with respect to any quantifiable variable. Inadvertent error can occur, for example, through the use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes a structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

1-15. (canceled)

16. A windrower (1) comprising of:
a main frame (2), which can be supported via an undercarriage (4) in the operating state, and having at least one windrower unit (20), which is connected at least indirectly to the main frame (2); and
a pickup device (21), and a transverse conveyor (30), which is arranged at least predominantly behind it in relation to a windrower longitudinal axis (X) in a working configuration of the windrower (1) and has a transverse conveyor frame (31), wherein the pickup device (21) is configured, in the working configuration, to pick up agricultural crop material from the ground (50) and to transfer it to the transverse conveyor (30), and the transverse conveyor (30) is configured to convey the transferred crop material along a windrower transverse axis (Y) and deposit it in windrows on the ground (50); wherein the pickup device (21) is vertically movable both relative to the transverse conveyor frame (31) and relative to the main frame (2), at least in relation to a windrower vertical axis (Z).

17. The windrower according to claim 16, wherein the pickup device (21) is connected in a vertically movable manner to the transverse conveyor frame (31) via a pickup suspension (35).

18. The windrower according to claim 17, wherein the pickup suspension (35) is arranged at least in part below and/or at least in part within the transverse conveyor (30).

19. The windrower according to claim 17, wherein the pickup suspension (35) has a plurality of suspension units (36, 37) spaced apart along the windrower transverse axis (Y).

20. The windrower according to claim 16, further comprising at least one suspension unit (36, 37) has a suspension link (38, 39) which extends forwards to the pickup device (21) from a region (32) of the transverse conveyor frame (31) which is at the rear in relation to the windrower longitudinal axis (X).

21. The windrower according to claim 16, further comprising at least one suspension unit (36, 37) has a double-link suspension, in particular a parallelogram suspension.

22. The windrower according to claim 16, wherein the pickup device (21) is configured to discharge the crop material above the transverse conveyor (30) in relation to the windrower vertical axis (Z) and to throw it onto the said conveyor.

23. The windrower according to claim 16, wherein the pickup device (21) can be deflected relative to the transverse conveyor frame (31) as far as a stop position, upon reaching which the pickup device (21) interacts with the transverse conveyor frame (31) via a positive engagement acting along the windrower vertical axis (Z).

24. The windrower according to claim 16, further comprising a stop position that is defined by one end of an aperture (40), which extends along the windrower vertical axis (Z), is closed on at least one side and into which there engages a stop part, which, when the pickup device (21) is deflected along the windrower vertical axis (Z), can be deflected relative to the aperture (40).

25. The windrower according to claim 16, wherein the pickup device (21) includes ground guidance elements (27), via which it can be supported at least proportionately on the ground.

26. The windrower according to claim 16, wherein the pickup device (21) is connected to the transverse conveyor frame (31) by at least one spring element (28), which is designed to exert a tensile force acting at least proportionately along the windrower vertical axis (Z).

27. The windrower according to claim 16, wherein the pickup device (21) includes two subunits (22), which are offset with respect to one another along the windrower transverse axis (Y) and can be tilted relative to one another about a bending axis (K) extending at least proportionately along the windrower longitudinal axis (X), wherein the subunits (22) are vertically movable relative to the transverse conveyor frame (31), at least partially independently of one another.

28. The windrower according to claim 16, wherein the transverse conveyor frame (31) is connected at least indirectly to the main frame (2) via a central link (8) and two lateral links (10), which are offset laterally along the windrower transverse axis (Y) with respect to the said central link and are at least partially offset with respect thereto along the windrower vertical axis (Z), wherein the central link (8) and the lateral links (10) are pivotably attached on both sides independently of one another and wherein each lateral link (10) can be pivoted by an actuator.

29. The windrower according to claim 28, wherein the central link (8) and the lateral links (10) are connected to a suspension frame (6), which can be pivoted by an actuator relative to the main frame (2) about a transport pivoting axis (T) running at least proportionately along the windrower transverse axis (Y).

30. The windrower according to claim 1, wherein the main frame (2) includes two side arms (5), and a respective windrower unit (20) is connected at least indirectly to each side arm (5).
